(19) United States
(12) Patent Application Publication
(10) Pub. No.: US 2014/0070026 A1
(43) Pub. Date: Mar. 13, 2014

(54) COMPOSITION FOR AEROSOL FOR CONTROLLING FLYING-INSECT PEST

(71) Applicant: SUMITOMO CHEMICAL COMPANY, LIMITED, Tokyo (JP)

(72) Inventor: Masahiro YAMADA, Takarazuka-shi (JP)

(73) Assignee: SUMITOMO CHEMICAL COMPANY, LIMITED, Tokyo (JP)

(21) Appl. No.: 14/025,474

(22) Filed: Sep. 12, 2013

(30) Foreign Application Priority Data
Sep. 13, 2012 (JP) 2012-201285

(51) Int. Cl. A01N 25/06; B65D 83/14

(52) U.S. Cl. CPC A01N 25/06; B65D 83/14
USPC 239/337; 424/43

(57) ABSTRACT

The present invention relates to a composition for an aerosol for controlling a flying-insect pest exhibiting an excellent controlling effect on a flying-insect pest, more specifically a composition for an aerosol for controlling a flying-insect pest, comprising a) at least one pyrethroid compound of formula (1):

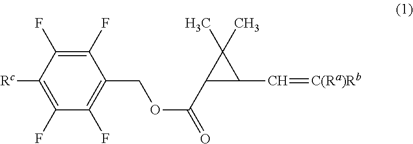

wherein R^{a} represents a hydrogen atom, a halogen atom or a methyl group, R^{b} represents a halogen atom, a methyl group, a trifluoromethyl group or a cyano group, and R^{c} represents a hydrogen atom, a methyl group, a propargyl group or a methoxymethyl group; b) a monoalcohol compound of formula (2):

HO—X (2)

wherein X represents an alkyl group having 2 to 4 carbon atoms; c) a hydrophobic organic solvent; and d) a propellant.

### TECHNICAL FIELD

The present application is filed claiming the priority based on Japanese Patent Application No. 2012-201285 (filed on Sep. 13, 2012), the entire content of which is incorporated herein by reference.

The present invention relates to a composition for an aerosol for controlling a flying-insect pest exhibiting an excellent controlling effect on a flying-insect pest.

### BACKGROUND ART

Compositions for an aerosol for controlling an insect pest containing a pyrethroid compound as an active ingredient are known. For example, Patent Literatures 1 to 3 describe compositions for an aerosol containing a certain pyrethroid compound.

### CITATION LIST

### Patent Literature

Patent Literature 1: JP 2010-077073 A
Patent Literature 2: JP 2011-144150 A
Patent Literature 3: JP 2012-082192 A

### SUMMARY OF INVENTION

### Technical Problem

An object of the present invention is to provide a composition for an aerosol for controlling a flying-insect pest exhibiting an excellent controlling effect on a flying-insect pest.

### Solution to Problem

As a result of an intensive study to obtain a composition for an aerosol for controlling a flying-insect pest having an excellent controlling effect on a flying-insect pest, the present inventor found that a composition for an aerosol containing a certain pyrethroid compound, a certain alcohol, an organic solvent and a propellant exhibits an excellent controlling effect on a flying-insect pest.

The present invention provides the followings:

[1] A composition for an aerosol for controlling a flying-insect pest, comprising
a) at least one pyrethroid compound of formula (1):

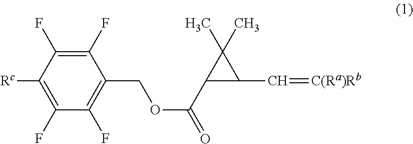

wherein
R^{a} represents a hydrogen atom, a halogen atom or a methyl group,
R^{b} represents a halogen atom, a methyl group, a trifluoromethyl group or a cyano group, and
R^{c} represents a hydrogen atom, a methyl group, a propargyl group or a methoxymethyl group (hereinafter referred to as “present pyrethroid compound”);
b) a monoalcohol compound of formula (2):

HO—X (2)

wherein
X represents an alkyl group having 2 to 4 carbon atoms (hereinafter referred to as “present alcohol compound”);
c) at least one hydrophobic organic solvent (hereinafter referred to as “present hydrophobic organic solvent”) selected from an alkyl carboxylate having 12 to 33 carbon atoms (hereinafter referred to as “present ester solvent”) and a saturated hydrocarbon having a boiling point of 150° C. or higher (hereinafter referred to as “present saturated hydrocarbon solvent”); and
d) a propellant.
[2] The composition according to [1] comprising
a) 0.3 to 3 wt % of at least one of the present pyrethroid compound,
b) 8 to 25 wt % of the present alcohol compound,
c) at least one of the present hydrophobic organic solvent, and
d) 35 to 65 wt % of the propellant;
wherein the total amount of a), b), c) and d) is 95 wt % or more based on the total amount of the composition.
[3] The composition according to [1] or [2], wherein the present alcohol compound is 2-propanol.
[4] The composition according to any one of [1] to [3], wherein the present hydrophobic organic solvent is combination of the present ester solvent and the saturated hydrocarbon solvent.
[5] An aerosol for controlling a flying-insect pest comprising the composition according to any one of [1] to [4] in a pressure-proof container with a spraying device (hereinafter referred to as “present aerosol”).
[6] A method for controlling a flying-insect pest, which comprises spraying the composition according to any one of [1] to [4] to a flying-insect pest or a location where a flying-insect pest is present (hereinafter referred to as “present controlling method”).

### Effects of Invention

The composition for an aerosol for controlling a flying-insect pest according to the present invention exhibits an excellent controlling effect on a flying-insect pest.

### DESCRIPTION OF EMBODIMENTS

The composition for an aerosol for controlling a flying-insect pest according to the present invention (hereinafter referred to as “present composition”) is used in charged into a pressure-proof container.

Specific examples of the present pyrethroid compound includes
4-methoxymethyl-2,3,5,6-tetrafluorobenzyl 2,2-dimethyl-3-(1-propenyl)cyclopropanecarboxylate (hereinafter referred to as “Compound A”),
4-methyl-2,3,5,6-tetrafluorobenzyl 2,2-dimethyl-3-(1-propenyl)cyclopropanecarboxylate (hereinafter referred to as “Compound B”),
4-methoxymethyl-2,3,5,6-tetrafluorobenzyl 2,2-dimethyl-3-(2-methyl-1-propenyl)cyclopropanecarboxylate (hereinafter referred to as “Compound C”),
4-methoxymethyl-2,3,5,6-tetrafluorobenzyl 2,2-dimethyl-3-(2-cyano-1-propenyl)cyclopropanecarboxylate (hereinafter referred to as “Compound D”),
4-methoxymethyl-2,3,5,6-tetrafluorobenzyl 2,2-dimethyl-3-(2,2-dichlorovinyl)cyclopropanecarboxylate (hereinafter referred to as “Compound E”),
4-methoxymethyl-2,3,5,6-tetrafluorobenzyl 2,2-dimethyl-3-(3,3,3-trifluoro-1-propenyl)cyclopropanecarboxylate (hereinafter referred to as “Compound F”), and
2,3,5,6-tetrafluorobenzyl 2,2-dimethyl-3-(2,2-dichlorovinyl)cyclopropanecarboxylate (hereinafter referred to as “Compound G”).

The present pyrethroid compounds are disclosed in JP 11-222463 A, JP 2000-63329 A, JP 2001-11022 A, JP 2004-002363 A, etc., and can be prepared by the processes disclosed in these publications.

The present pyrethroid compound may be present as isomers due to two asymmetric carbon atoms on the cyclopropane ring and the double bond. Any mixture containing active isomers at any ratio may be used for the present invention.

The amount of the present pyrethroid compound contained in the composition of the present invention is generally 0.1 to 10 wt %, preferably 0.3 to 3 wt %, based on the total amount of the composition.

In addition to the present pyrethroid compound, the composition of the present invention contains the present alcohol compound and the present hydrophobic organic solvent, which are liquids at room temperature. Hereinafter, the present alcohol compound and the present hydrophobic organic solvent are collectively referred to as “present solvent”. Namely, the present solvent includes a monoalcohol compound of formula (2), and an alkyl carboxylate having 12 to 33 carbon atoms and/or a saturated hydrocarbon having a boiling point of 150° C. or higher. The present solvent is preferably a mixture of a monoalcohol compound of formula (2), an alkyl carboxylate having 12 to carbon atoms and a saturated hydrocarbon having a boiling point of 150° C. or higher.

In the preparation of the composition of the present invention, the present solvent may be added to a pressure-proof container after mixing with the present pyrethroid compound; or the present pyrethroid compound and the present solvent may be separately added to a pressure-proof container.

Examples of the present alcohol compound include ethanol, propanol, 2-propanol, and butanol.

The amount of the present alcohol compound contained in the composition of the present invention is generally 5 to 30 wt %, preferably 8 to 25 wt %, based on the total amount of the composition.

The present hydrophobic organic solvent is at least one hydrophobic organic solvent selected from an alkyl carboxylate having 12 to 33 carbon atoms and a saturated hydrocarbon having a boiling point of 150° C. or higher. The present hydrophobic organic solvent may be either an alkyl carboxylate having 12 to 33 carbon atoms or a saturated hydrocarbon having a boiling point of 150° C. or higher; or a mixture of both solvents.

Examples of the alkyl carboxylate having 12 to 33 carbon atoms include alkyl carboxylates having 12 to 30 carbon atoms, specifically, for example, alkyl alkylcarboxylates having 12 to 30 carbon atoms such as isopropyl myristate, hexyl laurate, and isopropyl palmitate; dialkyl dicarboxylates having 12 to 30 carbon atoms such as diisopropyl adipate, dioctyl adipate, diisononyl adipate, and diisodecyl adipate; trialkyl acetylcitrates having 12 to 30 carbon atoms such as triethyl acetylcitrate, and tributyl acetylcitrate; trialkyl citrates having 12 to 30 carbon atoms such as triethyl citrate; and dialkyl phthalates having 12 to 30 carbon atoms such as dibutyl phthalate, and diisononyl phthalate.

Examples of the present ester solvent preferably include alkyl alkylcarboxylates having 12 to 30 carbon atoms, dialkyl dicarboxylates having 12 to 30 carbon atoms and trialkyl acetylcitrates having 12 to 30 carbon atoms, trialkyl citrates having 12 to 30 carbon atoms, and dialkyl phthalates having 12 to 30 carbon atoms, more preferably, alkyl alkylcarboxylates having 12 to 30 carbon atoms, dialkyl dicarboxylates having 12 to 30 carbon atoms, and trialkyl acetylcitrates having 12 to 30 carbon atoms.

Specific preferable examples of the present ester solvent include dibutyl phthalate, isopropyl myristate, diisopropyl adipate, dioctyl adipate, diisononyl adipate, diisodecyl adipate, triethyl acetylcitrate, tributyl acetylcitrate, and triethyl citrate, more preferably, isopropyl myristate, diisopropyl adipate, dioctyl adipate, diisononyl adipate, diisodecyl adipate, triethyl acetylcitrate, and tributyl acetylcitrate.

Examples of the saturated hydrocarbon having a boiling point of 150° C. or higher (the boiling point used herein is a value measured under atmospheric pressure) include saturated hydrocarbons such as straight-chain saturated hydrocarbons, branched saturated hydrocarbons, and alicyclic saturated hydrocarbons, and aromatic hydrocarbons, specifically Isopar M (a saturated hydrocarbon from ExxonMobil Yugen Kaisha, the boiling point: 223 to 254° C.), Isopar V (a saturated hydrocarbon from ExxonMobil Yugen Kaisha, the boiling point: 273 to 310° C.), IP Solvent 2835 (a saturated hydrocarbon from IDEMITSU KOSAN CO., LTD., the boiling point: 277 to 353° C.), Norpar 13 (a saturated hydrocarbon from ExxonMobil Yugen Kaisha, the boiling point: 222 to 242° C.), Norpar 15 (a saturated hydrocarbon from ExxonMobil Yugen Kaisha, the boiling point: 249 to 274° C.), Neo-chiozol (a saturated hydrocarbon from Chuo Kasei Co., Ltd, the boiling point: 225 to 247° C.), Exxsol D110 (a saturated hydrocarbon from ExxonMobil Yugen Kaisha, the boiling point: 249 to 267° C.), Exxsol D130 (a saturated hydrocarbon from ExxonMobil Yugen Kaisha, the boiling point: 279 to 313° C.), CACTUS normal paraffin N-12 (a saturated hydrocarbon of Japan Energy Corporation, the boiling point: 209 to 212° C.), CACTUS normal paraffin N-13 (a saturated hydrocarbon of Japan Energy Corporation, the boiling point: 226 to 229° C.), CACTUS normal paraffin N-14 (a saturated hydrocarbon of Japan Energy Corporation, the boiling point: 260 to 276° C.), CACTUS normal paraffin N-15H (a saturated hydrocarbon of Japan Energy Corporation, the boiling point: 209 to 212° C.), and CACTUS normal paraffin YHNP (a saturated hydrocarbon of Japan Energy Corporation, the boiling point: 222 to 242° C.)

The total amount of the present alcohol compound and the present hydrophobic organic solvent in the composition of the present invention is generally 28 to 69 wt %. The weight ratio of the present alcohol compound to the present hydrophobic organic solvent in the composition of the present invention is generally 1:12 to 7:3, preferably 1:8 to 7:3, more preferably 2:8 to 5:5.

Examples of the propellant contained in the composition of the invention include nitrogen gas, compressed air, carbon dioxide gas, liquefied petroleum gases (LPG), and dimethyl ether. The propellant contained in the composition of the invention may be used alone or in combination of two or more. In the present invention, the propellant preferably includes liquefied petroleum gases.

The amount of the propellant in the composition of the present invention is generally 25 to 70 wt %, preferably 35 to 65 wt %, based on the total amount of the composition.

The composition of the present invention can contain formulation additives unless there is a loss of the controlling effect of the present pyrethroid compound on a flying-insect pest. Examples of the formulation additives include the other agents for controlling a flying-insect pest, the other solvents, repellents, synergists, stabilizers, flavors, and the like.

The composition of the present invention can contain the formulation additives in an amount of less than 10 wt %, preferably less than 5 wt %, based on the total amount of the composition.

Therefore, the total amount of a) the present pyrethroid compound, b) the present alcohol compound, c) the present hydrophobic organic solvent, and d) the propellant in the composition of the present invention is not less than 90 wt %, preferably not less than 95 wt %.

Examples of the other agent for controlling a flying-insect pest include organic phosphorus compounds such as dichlorvos, fenitrothion, tetrachlorvinphos, fenthion, chlorpyrifos, and diazinon; carbamate compounds such as propoxur, carbaryl, metoxadiazone, and fenobucarb; inhibitors of chitin formation such as lufenuron, chlorfluazuron, hexaflumuron, diflubenzuron, cyromazine, and 1-(2,6-difluorobenzoyl)-3-[2-fluoro-4-(1,1,2,3,3,3-hexafluoropropoxy)phenyl]urea; juvenile hormone-like agents such as pyriproxyfen, methoprene, hydroprene, and fenoxycarb; neonicotinoid compounds; and N-phenylpyrazole compounds.

Examples of the other solvent include propylene carbonate, ethylene carbonate, sulfolane, N,N-dimethylformamide, dimethyl sulfoxide, γ-butyrolactone, N-methyl-2-pyrrolidone, N-ethyl-2-pyrrolidone, N-octyl-2-pyrrolidone, and 1,3-dimethyl-2-imidazolidinone.

Examples of the repellent include N,N-diethyl-m-toluamide, limonene, linalool, citronellal, menthol, menthone, hinokitiol, geraniol, eucalyptol, indoxacarb, carane-3,4-diol, MGK-R-326, MGK-R-874, and BAY-KBR-3023.

Examples of the synergist include 5-[2-(2-butoxyethoxy)ethoxymethyl]-6-propyl-1,3-benzodioxole, N-(2-ethylhexyl)bicyclo[2.2.1]hept-5-ene-2,3-dicarboxylmide, octachlorodipropyl ether, isobornyl thiocyanoacetate, and N-(2-ethylhexyl)-1-isopropyl-4-methylbicyclo[2.2.2]oct-5-ene-2,3-dicarboxylmide.

Examples of the stabilizer include phenolic antioxidants such as 2,6-di-t-butyl-4-methylphenol.

The formulation additives is generally mixed with the present pyrethroid compound and/or the present solvent, and then added to a pressure-proof container.

The present aerosol comprises the composition of the present invention included in a pressure-proof container with a spraying device. The spraying device has at least an aerosol valve and an actuator, and can spray the content of the container in a certain direction by the pressure due to the change in state of the propellant from a liquid to a gas. The pressure-proof container is generally a can made of metal, but the material of the container is not limited thereto.

The aerosol valve is not particularly limited, but is generally a push down-type aerosol valve. Examples of the actuator include straight type actuators and actuators having mechanical break-up system.

The present aerosol can be prepared, for example, by charging the present pyrethroid compound and the present solvent, and, if necessary, formulation additives into a pressure-proof container; attaching an aerosol valve to the container; filling the container with a propellant via a stem; shaking the container; and attaching an actuator to the container.

The present aerosol preferably has an actuator having mechanical break-up system. Examples of the actuator include those described in JP 2010-235174 A.

The present controlling method can be carried out by spraying the composition of the present invention to a flying-insect pest or a location where a flying-insect pest is present by means of the present aerosol, thereby controlling a flying-insect pest.

In the present controlling method, an effective amount of the composition of the present invention can be sprayed in the form of a mist, thereby exhibiting an excellent controlling effect on a flying-insect pest in a widespread area. The controlling effect may be maintained in a certain period after spraying.

In the present invention, the “location” includes a space, a plane, and like.

The amount of the composition of the present invention to be sprayed to a space is generally 0.001 to 1000 mg/m³, preferably 0.001 to 100 mg/m³, more preferably 0.01 to 10 mg/m³ in terms of the amount of the present pyrethroid compound. The amount of the composition of the present invention to be sprayed to a plane is generally 0.0001 to 1000 mg/m². Examples of the space where the composition of the present invention is sprayed include room interiors, living rooms, dining rooms, closets, wardrobes, chests such as Japanese chests, cupboards, toilets, bathrooms, storerooms, warehouses, and car interiors. Furthermore, the composition can also be sprayed to outside open space.

Examples of the flying-insect pest which can be controlled by the composition of the present invention include Diptera, for example, Culex spp. such as Culex pipiens pallens and Culex tritaeniorhynchus; Aedes spp. such as Aedes aegypti and Aedes albopictus; Anophelinae such as Anopheles sinensis; Chironomidae; Muscidae such as Musca domestica and Muscina stabulans; Calliphoridae; Sarcophagidae; Anthomyiidae such as Fannia canicularis, Delia platura and Delia antiqua; Tephritidae; Drosophilidae; Psychodidae; Tabanidae; Simuliidae; Stomoxyini; and the like; and Lepidoptera such as Tinea translucens and Tineola bisselliella; and the like.

### EXAMPLES

Hereinafter, the present invention is further described in detail with reference to Examples such as preparation examples and test examples, to which the present invention is not limited.

First, preparation examples of aerosol for controlling a flying-insect pest containing the composition of the invention are described. The term “part(s)” used herein means part(s) by weight.

### Preparation Example 1

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 10 parts of 2-propanol, 10 parts of isopropyl myristate, and 17.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Preparation Example 2

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 20 parts of 2-propanol, and 37.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 3

Into an aerosol container, 0.45 parts of 4-methoxymethyl-2,3,5,6-tetrafluorobenzyl 2,2-dimethyl-3-(2,2-dichlorovinyl)cyclopropanecarboxylate, 10 parts of 2-propanol, 15 parts of diisopropyl adipate, and 34.55 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 4

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 10 parts of 2-propanol, and 47.13 parts of isopropyl myristate were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 5

Into an aerosol container, 0.45 parts of 4-methoxymethyl-2,3,5,6-tetrafluorobenzyl 2,2-dimethyl-3-[(2-cyano-1-propenyl(E/Z=1/9)]cyclopropanecarboxylate, 2.42 parts of propylene carbonate, 10 parts of 2-propanol, 20 parts of diisopropyl adipate, and 7.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Preparation Example 6

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 10 parts of 2-propanol, and 27.13 parts of diisopropyl adipate were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Preparation Example 7

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 15 parts of 2-propanol, 15 parts of diisopropyl adipate, and 27.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 8

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 20 parts of 2-propanol, 20 parts of diisopropyl adipate, and 17.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 9

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 10 parts of 2-propanol, and 47.13 parts of diisopropyl adipate were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 10

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 10 parts of 2-propanol, 20 parts of isopropyl myristate, and 27.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 11

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 5 parts of 2-propanol, 15 parts of diisopropyl adipate, and 37.13 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 12

Into an aerosol container, 0.45 parts of 4-methoxymethyl-2,3,5,6-tetrafluorobenzyl 2,2-dimethyl-3-(3,3,3-trifluoro-1-propenyl)cyclopropanecarboxylate, 10 parts of 2-propanol, 15 parts of diisopropyl adipate, and 34.55 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 13

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 0.45 parts of 4-methoxymethyl-2,3,5,6-tetrafluorobenzyl 2,2-dimethyl-3-(1-propenyl)cyclopropanecarboxylate, 10 parts of 2-propanol, 15 parts of isopropyl myristate, and 34.10 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Preparation Example 14

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 0.45 parts of 4-methoxymethyl-2,3,5,6-tetrafluorobenzyl 2,2-dimethyl-3-(1-propenyl)cyclopropanecarboxylate, 0.90 parts of 3-phenoxybenzyl 2,2-dimethyl-3-(2-methyl-1-propenyl)cyclopropanecarboxylate, 10 parts of 2-propanol, 15 parts of isopropyl myristate, and 33.20 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Comparative Example 1

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, and 37.13 parts of Neo-chiozol (manufactured by Chuo Kasei Co., Ltd.) are added. Then, a valve part with a stem having an orifice diameter of 0.25 mm, a housing having a main orifice diameter of 0.33 mm and no vapor tap is attached to the aerosol container. The aerosol container is filled with 60 parts of a propellant (liquefied petroleum gas) via the valve part. A mechanical break-up actuator with a spray outlet having an orifice diameter of 0.30 mm is attached to the aerosol container to obtain an aerosol.

### Comparative Example 2

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 2.42 parts of propylene carbonate, 8 parts of diisopropyl adipate, and 29.13 parts of Neo-chiozol (manufactured by Chuo Kasei Co., Ltd.) are added. Then, a valve part with a stem having an orifice diameter of 0.25 mm, a housing having a main orifice diameter of 0.33 mm and no vapor tap is attached to the aerosol container. The aerosol container is filled with 60 parts of a propellant (liquefied petroleum gas) via the valve part. A mechanical break-up actuator with a spray outlet having an orifice diameter of 0.30 mm is attached to the aerosol container to obtain an aerosol.

### Comparative Example 3

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 8 parts of diisopropyl adipate, and 31.55 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Comparative Example 4

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, 8 parts of diisopropyl adipate, and 51.55 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol.

### Comparative Example 5

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, and 39.55 parts of Neo-chiozol (manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Comparative Example 6

Into an aerosol container, 0.45 parts of 4-methoxymethyl-2,3,5,6-tetrafluorobenzyl 2,2-dimethyl-3-[2-cyano-1-propenyl(E/Z=1/9)]cyclopropanecarboxylate, and 39.55 parts of 2-propanol were added. Then, a valve part with a stem having an orifice diameter of 0.25 mm, a housing having a main orifice diameter of 0.33 mm and no vapor tap was attached to the aerosol container. The aerosol container was filled with 60 parts of a propellant (liquefied petroleum gas) via the valve part. A mechanical break-up actuator with a spray outlet having an orifice diameter of 0.30 mm was attached to the aerosol container to obtain an aerosol.

### Test Example

Into a polyethylene cup having a lower-part diameter of 10.6 cm, an upper-part diameter of 12 cm, and a height of 7 cm were released 10 adults (5 males and 5 females) of Musca domestica, and then the cup was closed with a nylon cloth having 16 mesh. A similar cup without insects was put into a cubic chamber (70 cm×70 cm×70 cm) and placed near the center of the bottom.

From a small window in the center of the front side, an aerosol composition was sprayed into the chamber in an amount such that the present active ingredient (the present pyrethroid compound) was 2.7 mg. 30 seconds later from spraying, the cup containing insects was placed near the center of the bottom of the chamber. Then, 1 minute 30 seconds later, the number of knock-down Musca domestica was counted. The results are shown in the following Table.

| | TABLE |
|---|---|
| | Ratio (%) of Knock Down after |
| | 1 min 30 sec. |
| Preparation Example 1 | 100 |
| Preparation Example 2 | 70 |
| Preparation Example 11 | 60 |
| Comparative Example 3 | 10 |

### INDUSTRIAL AVAILABILITY OF INVENTION

The composition of the invention has an excellent controlling effect on a flying-insect pest.

1. A composition for an aerosol for controlling a flying-insect pest, comprising
a) at least one pyrethroid compound of formula (1): 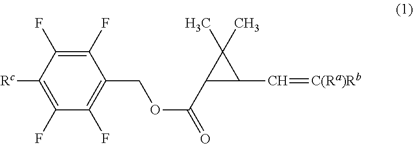
wherein
R^{a} represents a hydrogen atom, a halogen atom or a methyl group,
R^{b} represents a halogen atom, a methyl group, a trifluoromethyl group or a cyano group, and
R^{c} represents a hydrogen atom, a methyl group, a propargyl group or a methoxymethyl group;
b) a monoalcohol compound of formula (2):
HO—X (2)
wherein
X represents an alkyl group having 2 to 4 carbon atoms;
c) at least one hydrophobic organic solvent selected from an alkyl carboxylate having 12 to 33 carbon atoms and a saturated hydrocarbon having a boiling point of 150° C. or higher; and
d) a propellant.

2. The composition according to claim 1 comprising
a) 0.3 to 3 wt % of at least one of the pyrethroid compound of formula (1),
b) 8 to 25 wt % of the monoalcohol compound of formula (2),
c) at least one of the hydrophobic organic solvent, and
d) 35 to 65 wt % of the propellant;
wherein the total amount of a), b), c) and d) is 95 wt % or more based on the total amount of the composition.

3. The composition according to claim 1, wherein the monoalcohol compound of formula (2) is 2-propanol.

4. The composition according to claim 1, wherein the hydrophobic organic solvent is a combination of an alkyl carboxylate having 12 to 33 carbon atoms and a saturated hydrocarbon having a boiling point of 150° C. or higher.

5. An aerosol for controlling a flying-insect pest comprising the composition according to claim 1 in a pressure-proof container with a spraying device.

6. A method for controlling a flying-insect pest, which comprises spraying the composition according to claim 1 to a flying-insect pest or a location where a flying-insect pest is present.

7. The composition according to claim 2, wherein the monoalcohol compound of formula (2) is 2-propanol.

8. The composition according to claim 2, wherein the hydrophobic organic solvent is a combination of an alkyl carboxylate having 12 to 33 carbon atoms and a saturated hydrocarbon having a boiling point of 150° C. or higher.

9. The composition according to claim 3, wherein the hydrophobic organic solvent is a combination of an alkyl carboxylate having 12 to 33 carbon atoms and a saturated hydrocarbon having a boiling point of 150° C. or higher.

10. An aerosol for controlling a flying-insect pest comprising the composition according to claim 2 in a pressure-proof container with a spraying device.

11. An aerosol for controlling a flying-insect pest comprising the composition according to claim 3 in a pressure-proof container with a spraying device.

12. An aerosol for controlling a flying-insect pest comprising the composition according to claim 4 in a pressure-proof container with a spraying device.

13. A method for controlling a flying-insect pest, which comprises spraying the composition according to claim 2 to a flying-insect pest or a location where a flying-insect pest is present.

14. A method for controlling a flying-insect pest, which comprises spraying the composition according to claim 3 to a flying-insect pest or a location where a flying-insect pest is present.

15. A method for controlling a flying-insect pest, which comprises spraying the composition according to claim 4 to a flying-insect pest or a location where a flying-insect pest is present.
